(19) United States
(12) Patent Application Publication
(10) Pub. No.: US 2026/0352968 A1
(43) Pub. Date: Nov. 5, 2026

(54) SOLID-STATE IMAGING ELEMENT AND IMAGING DEVICE

(71) Applicant: Sony Semiconductor Solutions Corporation, Kanagawa (JP)

(72) Inventors: Mizuki Honda, Kanagawa (JP); Kohei Hanasaki, Kanagawa (JP); Yuji Torige, Kanagawa (JP)

(21) Appl. No.: 19/484,529

(22) PCT Filed: Apr. 24, 2024
(86) PCT No.: PCT/JP2024/016028

§ 371 Date: Nov. 14, 2025

(30) Foreign Application Priority Data
Jun. 19, 2023 (JP) 2023-099740

(51) Int. Cl. H04N 25/47; H04N 25/77

(52) U.S. Cl. CPC H04N 25/47; H04N 25/77

(57) ABSTRACT

Solid-state imaging elements that detect address events are disclosed. In one example, a solid-state imaging element includes a light receiving chip and a circuit chip. On the light receiving chip, a transfer transistor that opens and closes a path between a photoelectric conversion element and a contact among a gradation pixel that generates a gradation signal according to a light amount and a detection pixel that detects whether or not a change amount of luminance exceeds a predetermined threshold is arranged. In the circuit chip, a transistor that does not correspond to the transfer transistor among the gradation pixel and the detection pixel is arranged.

### TECHNICAL FIELD

The present technology relates to a solid-state imaging element. Specifically, the present technology relates to a solid-state imaging element having a laminated structure and an imaging device.

### BACKGROUND ART

In recent years, in various fields such as traffic and robots, development and research of a sensor that detects that a change amount of luminance exceeds a threshold for each pixel as an address event are in progress. Such a sensor is called a dynamic vision sensor (DVS) or an event-based vision sensor (EVS). For example, there has been proposed an imaging device in which a pixel signal generation unit that generates a pixel signal and a current-voltage conversion unit in a pixel that detects an address event share a floating diffusion layer or the like (see, for example, Patent Document 1). In FIG. 53 of this document, four transfer transistors are inserted between four photoelectric conversion elements and the floating diffusion layer, and two switching transistors are inserted between the floating diffusion layer and the pixel signal generation unit, and the current-voltage conversion unit. These six transistors are arranged on a light receiving chip, and the remaining transistors are arranged on a circuit chip.

### CITATION LIST

### Patent Document

Patent Document 1: WO 2020/100663 A

### SUMMARY OF THE INVENTION

### Problems to be Solved by the Invention

In the above-described conventional technology, the pixel signal generation unit and the pixel that detects the address event share the floating diffusion layer and the photoelectric conversion element, thereby suppressing an increase in circuit scale. However, in the above-described imaging device, it is necessary to arrange a switching transistor in addition to the transfer transistor in the light receiving chip, and there is a possibility that man-hours in manufacturing the light receiving chip increases.

The present technology has been made in view of such a situation, and an object thereof is to reduce man-hours for a solid-state imaging element that detects an address event.

### Solutions to Problems

The present technology has been made to solve the above-described problem, and a first aspect of the present technology is a solid-state imaging element including a light receiving chip on which a transfer transistor that opens and closes a path between a photoelectric conversion element and a contact is arranged among a gradation pixel that generates a gradation signal according to a light amount and a detection pixel that detects whether or not a change amount of luminance exceeds a predetermined threshold, and a circuit chip on which a transistor that does not correspond to the transfer transistor among the gradation pixel and the detection pixel is arranged. This brings about an effect of reducing man-hours.

Furthermore, in the first aspect, the gradation pixel may include a floating diffusion layer and a gradation signal generation unit that generates the gradation signal from a potential of the floating diffusion layer; the detection pixel may include a logarithmic response unit; the floating diffusion layer may be arranged on the light receiving chip; and the gradation signal generation unit and the logarithmic response unit may be arranged on the circuit chip. This brings about an effect that a gradation signal and a logarithmic voltage are generated in the circuit chip.

Furthermore, in the first aspect, the photoelectric conversion element may include a first photoelectric conversion element in the gradation pixel and a second photoelectric conversion element in the detection pixel; the contact may include a first contact connected to the gradation signal generation unit and a second contact connected to the logarithmic response unit; and the transfer transistor may include a first transfer transistor that opens and closes a path between the first photoelectric conversion element and the first contact and a second transfer transistor that opens and closes a path between the second photoelectric conversion element and the second contact. This brings about an effect that a gradation signal can be generated during detection of an address event.

Furthermore, in the first aspect, a first switching transistor that opens and closes a path between the contact and the gradation signal generation unit and a second switching transistor that opens and closes a path between the contact and the logarithmic response unit may be further arranged on the circuit chip. This brings about an effect of reducing the number of contacts.

Furthermore, in the first aspect, a switching transistor that opens and closes a path between the contact and the logarithmic response unit may be further arranged on the circuit chip, and the contact may be connected to the logarithmic response unit. This brings about an effect that the number of switching transistors is reduced.

Furthermore, in the first aspect, the gradation signal generation unit may include: a reset transistor that initializes the floating diffusion layer; an amplification transistor that amplifies a potential of the floating diffusion layer to generate the gradation signal; and a selection transistor that supplies the gradation signal to a vertical signal line in accordance with a predetermined selection signal. This brings about an effect that a gradation signal is generated.

Furthermore, in the first aspect, the gradation signal generation unit may further include a conversion efficiency control transistor that controls charge-voltage conversion efficiency of the floating diffusion layer. This brings about an effect that charge-voltage conversion efficiency is adjusted.

Furthermore, in the first aspect, the detection pixel may include a logarithmic response unit that converts a photocurrent into a logarithmic voltage, a buffer that outputs an output voltage corresponding to the logarithmic voltage, a subtractor that obtains a change amount of the output voltage by a subtraction operation, a quantizer that compares the change amount with a predetermined threshold to generate a comparison result, and a transfer unit that outputs a detection signal on the basis of the comparison result. The logarithmic response unit, the buffer, the subtractor, the quantizer, and the transfer unit may be arranged on the circuit chip. This brings about an effect that an address event is detected.

Furthermore, in the first aspect, the circuit chip may include a pixel transistor layer and a circuit layer; the logarithmic response unit may include a current source transistor that supplies a predetermined current, a log transistor that converts the photocurrent into the logarithmic voltage, and a transimpedance amplifier that inversely amplifies the logarithmic voltage; the gradation signal generation unit, the log transistor, and the transimpedance amplifier may be arranged on the pixel transistor layer; and the current source transistor, the buffer, the subtractor, the quantizer, and the transfer unit may be arranged on the circuit layer. This brings about an effect of suppressing interference.

Furthermore, a second aspect of the present technology is an imaging device including: a light receiving chip on which a transfer transistor that opens and closes a path between a photoelectric conversion element and a contact is arranged among a gradation pixel that generates a gradation signal according to a light amount and a detection pixel that detects whether or not a change amount of luminance exceeds a predetermined threshold; a circuit chip on which a transistor that does not correspond to the transfer transistor among the gradation pixel and the detection pixel is arranged; and a recording unit that records data from the circuit chip. This brings about an effect of reducing man-hours.

### BRIEF DESCRIPTION OF DRAWINGS

FIG. 1 is a block diagram illustrating a configuration example of an imaging device according to a first embodiment of the present technology.

FIG. 2 is a diagram illustrating an example of a laminated structure of a solid-state imaging element according to the first embodiment of the present technology.

FIG. 3 is a block diagram illustrating a configuration example of the solid-state imaging element according to the first embodiment of the present technology.

FIG. 4 is an example of a plan view of a pixel array unit according to the first embodiment of the present technology.

FIG. 5 is a circuit diagram illustrating a configuration example of a shared block in which eight gradation pixels are arranged according to the first embodiment of the present technology.

FIG. 6 is a circuit diagram illustrating a configuration example of a shared block in which four gradation pixels are arranged according to the first embodiment of the present technology.

FIG. 7 is a circuit diagram illustrating a configuration example of a shared block in which EVS pixels are arranged according to the first embodiment of the present technology.

FIG. 8 is an example of a circuit diagram of gradation pixels in a case where a floating diffusion layer is not shared according to the first embodiment of the present technology.

FIG. 9 is a circuit diagram illustrating a configuration example of a logarithmic response unit, a buffer, a subtractor, and a quantizer according to the first embodiment of the present technology.

FIG. 10 is an example of a cross-sectional view of the solid-state imaging element according to the first embodiment of the present technology.

FIG. 11 is a plan view illustrating an example of a layout of photoelectric conversion elements and transistors according to the first embodiment of the present technology.

FIG. 12 is a plan view illustrating another example of the layout according to the first embodiment of the present technology.

FIG. 13 is a circuit diagram illustrating a configuration example of a shared block in a comparative example.

FIG. 14 is a plan view illustrating the example of the layout in the comparative example.

FIG. 15 is a circuit diagram illustrating a configuration example of a shared block in which eight gradation pixels are arranged according to a modification of the first embodiment of the present technology.

FIG. 16 is a plan view illustrating the example of the layout of the modification of the first embodiment of the present technology.

FIG. 17 is an example of a plan view of a pixel array unit according to a second embodiment of the present technology.

FIG. 18 is a circuit diagram illustrating a configuration example of a shared block according to the second embodiment of the present technology.

FIG. 19 is a plan view illustrating an example of a layout according to the second embodiment of the present technology.

FIG. 20 is a circuit diagram illustrating a configuration example of a shared block according to a third embodiment of the present technology.

FIG. 21 is a plan view illustrating an example of a layout according to the third embodiment of the present technology.

FIG. 22 is a block diagram illustrating a schematic configuration example of a vehicle control system.

FIG. 23 is an explanatory view illustrating an example of an installation position of an imaging section.

### MODE FOR CARRYING OUT THE INVENTION

Hereinafter, modes for carrying out the present technology (hereinafter referred to as embodiments) will be described. The description will be given in the following order.
1. First embodiment (example in which transfer transistor is arranged on light receiving chip)
2. Second embodiment (example in which transfer transistor is arranged on light receiving chip and switching transistor is arranged on circuit chip)
3. Third embodiment (example in which transfer transistor is arranged on light receiving chip and switching transistor of circuit chip is eliminated)
4. Example of application to mobile body

### 1. First Embodiment

### Configuration Example of Imaging Device

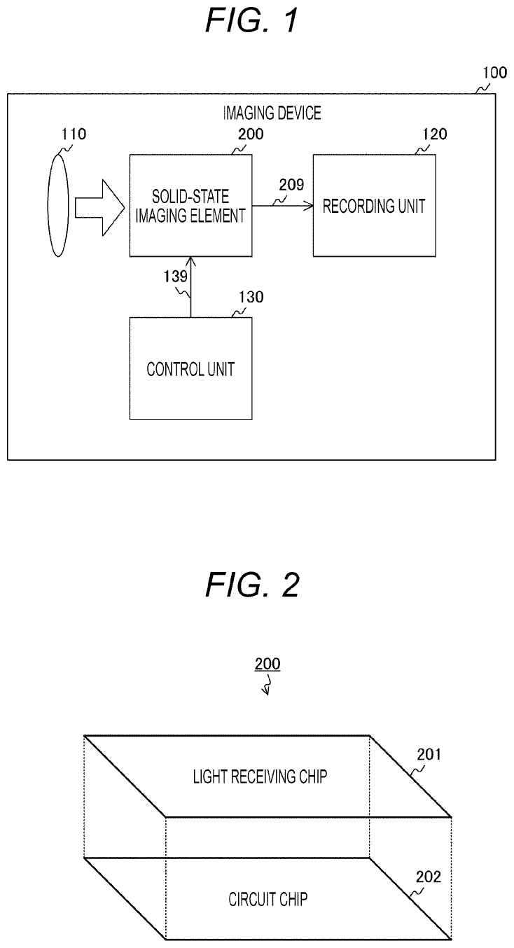

FIG. 1 is a block diagram illustrating a configuration example of an imaging device 100 according to an embodiment of the present technology. The imaging device 100 includes an imaging lens 110, a solid-state imaging element 200, a recording unit 120, and a control unit 130. As the imaging device 100, a smartphone, a camera mounted on an industrial robot, an in-vehicle camera, and the like are assumed.

The imaging lens 110 condenses incident light and guides the light to the solid-state imaging element 200. The solid-state imaging element 200 photoelectrically converts incident light to capture image data.

Furthermore, the solid-state imaging element 200 can detect the presence or absence of an address event and generate a detection signal. The solid-state imaging element 200 outputs the image data to the recording unit 120 via a signal line 209.

The recording unit 120 records the data from the solid-state imaging element 200. The control unit 130 controls the solid-state imaging element 200 to detect an address event and capture image data.

### Configuration Example of Solid-State Imaging Element

FIG. 2 is a diagram illustrating an example of a laminated structure of the solid-state imaging element 200 according to the first embodiment of the present technology. The solid-state imaging element 200 includes a circuit chip 202 and a light receiving chip 201 laminated on the circuit chip 202. These chips are electrically connected by, for example, Cu—Cu bonding. Note that in addition to the Cu—Cu bonding, the connection can be made using a via or a bump.

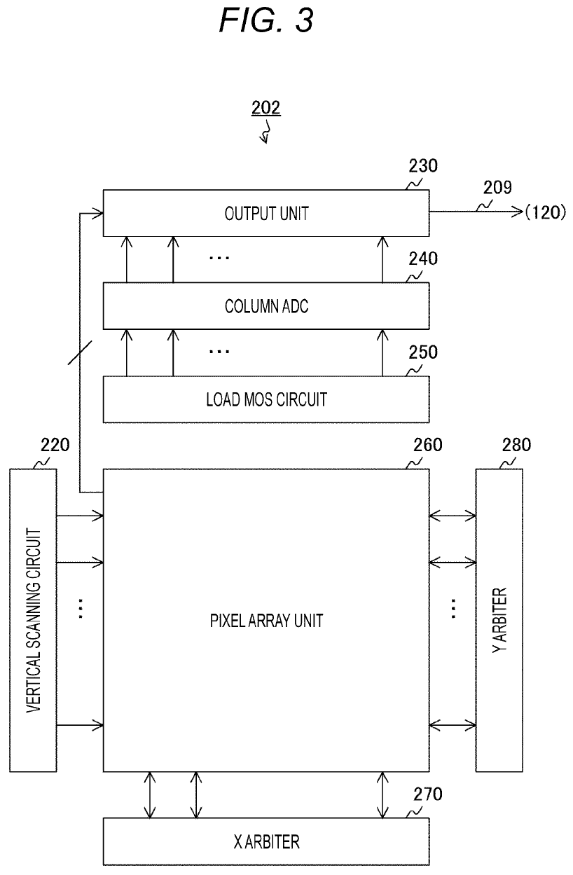

FIG. 3 is a block diagram illustrating a configuration example of the solid-state imaging element 200 according to the first embodiment of the present technology. The solid-state imaging element 200 includes a vertical scanning circuit 220, an output unit 230, a column analog to digital converter (ADC) 240, and a load metal-oxide-semiconductor (MOS) circuit 250.

Furthermore, the solid-state imaging element 200 includes a pixel array unit 260, an X arbiter 270, and a Y arbiter 280. In the pixel array unit 260, a plurality of pixels is arranged in a two-dimensional lattice pattern.

The vertical scanning circuit 220 drives each of the pixels to output an analog gradation signal. Additionally, some of the pixels can detect address events.

The Y arbiter 280 arbitrates a request from each of the rows in the pixel array unit 260 and returns a response on the basis of the arbitration result. The X arbiter 270 arbitrates a request from each of the columns in the pixel array unit 260 and returns a response on the basis of the arbitration result.

In the load MOS circuit 250, a load MOS current source connected to the vertical signal line of the column is arranged for each column.

In the column ADC 240, the ADC is arranged for each column. The ADC performs analog to digital (AD) conversion on the gradation signal from the corresponding column and supplies it to the output unit 230.

The output unit 230 processes the signal from the column ADC 240 and outputs the processing result to the recording unit 120. For example, the output unit 230 performs various types of signal processing such as correlated double sampling (CDS) processing on the gradation signal, and generates image data in which the processed signals are arranged. Furthermore, the output unit 230 performs image recognition processing and the like on a detection signal of an address event.

Here, the address event includes, for example, at least one of an on-event indicating that the change amount of the photocurrent exceeds an upper limit threshold or an off-event indicating that the change amount falls below a lower limit threshold. Furthermore, the detection signal of an address event includes, for example, at least one of one bit indicating the detection result of an on-event and one bit indicating the detection result of an off-event.

As described above, a method of outputting the detection signal of an address event asynchronously by arbiter arbitration is called an arbiter method. Note that in the solid-state imaging element 200, a scanning method in which the vertical scanning circuit 220 scans in units of rows and outputs detection signals in units of rows can be used instead of the arbiter method.

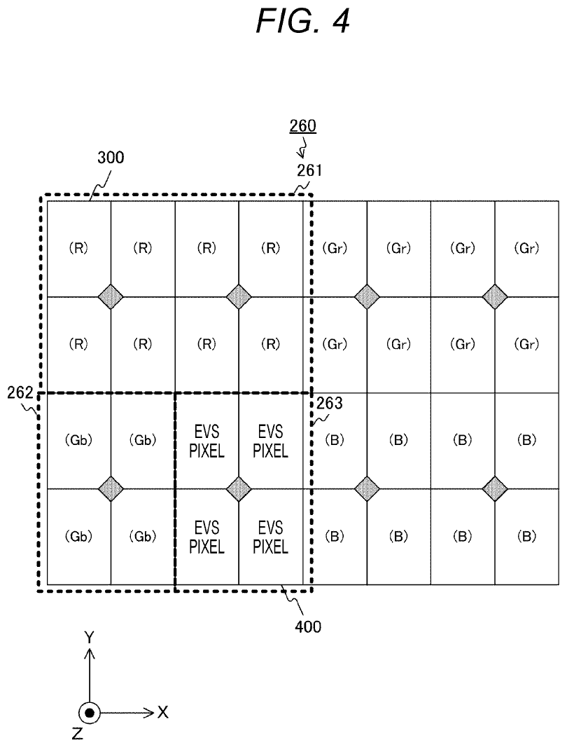

FIG. 4 is an example of a plan view of the pixel array unit 260 according to the first embodiment of the present technology. In the pixel array unit 260, a predetermined number of gradation pixels 300 and a predetermined number of EVS pixels 400 are arranged in a two-dimensional lattice pattern.

Hereinafter, an optical axis is defined as a Z-axis, and a predetermined axis perpendicular to the Z-axis is defined as an X-axis. An axis perpendicular to the X-axis and the Z-axis is defined as a Z-axis. The pixels (gradation pixels 300 and EVS pixels 400) in the pixel array unit 260 are arranged along the X-axis direction and the Y-axis direction.

The gradation pixel 300 generates a gradation signal corresponding to the light amount. The gradation signal includes, for example, color information of red (R), green (G), or blue (B). Hereinafter, the gradation pixels 300 that generate the gradation signals of R, G, and B are referred to as “R pixel”, “B pixel”, and “G pixel”. Of the G pixels, a pixel arranged in a row of R pixels is referred to as a “Gr pixel”, and a pixel arranged in a row of B pixels is referred to as a “Gb pixel”.

Furthermore, the EVS pixel 400 detects whether or not a change amount of luminance exceeds a predetermined threshold (i.e., presence or absence of address event). Note that the EVS pixel 400 is an example of a detection pixel recited in the claims.

Furthermore, the gradation pixels 300 and the EVS pixels 400 are arranged in shared blocks such as shared blocks 261, 262, and 263. A plurality of pixels are arranged in these shared blocks, and these pixels share some circuits.

For example, in the shared block 261, eight R pixels are arranged in 2 rows×4 columns. Among them, four adjacent pixels share a floating diffusion layer.

In addition, the eight Gr pixels share some circuits similarly to the shared block 261, and the eight B pixels share some circuits similarly to the shared block 261.

In the shared block 262, four Gb pixels are arranged in 2 rows×2 columns. These four pixels share a floating diffusion layer. In the shared block 263, four EVS pixels 400 are arranged in 2 rows×2 columns. These four pixels share some circuits.

Note that the number of pixels in a shared block is not limited to eight pixels or four pixels.

### Configuration Example of Shared Block

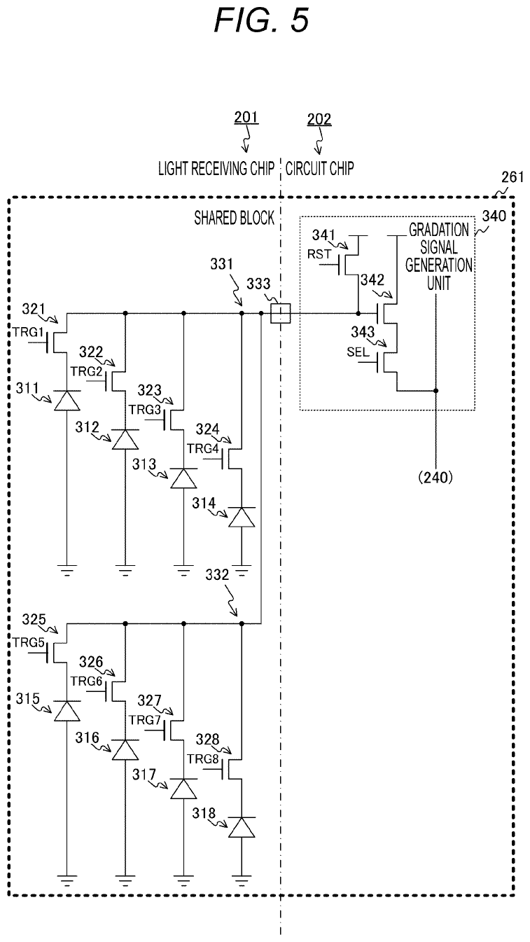

FIG. 5 is a circuit diagram illustrating a configuration example of the shared block 261 in which eight gradation pixels 300 are arranged according to the first embodiment of the present technology. The shared block 261 includes photoelectric conversion elements 311 to 318, transfer transistors 321 to 328, floating diffusion layers 331 and 332, and a gradation signal generation unit 340.

The photoelectric conversion elements 311 to 318 generate charge by photoelectric conversion. The transfer transistor 321 transfers charge from the photoelectric conversion element 311 to the floating diffusion layer 331 in accordance with a transfer signal TRG1 from the vertical scanning circuit 220. The transfer transistor 322 transfers charge from the photoelectric conversion element 312 to the floating diffusion layer 331 in accordance with a transfer signal TRG2 from the vertical scanning circuit 220. The transfer transistor 323 transfers charge from the photoelectric conversion element 313 to the floating diffusion layer 331 in accordance with a transfer signal TRG3 from the vertical scanning circuit 220. The transfer transistor 324 transfers charge from the photoelectric conversion element 314 to the floating diffusion layer 331 in accordance with a transfer signal TRG4 from the vertical scanning circuit 220.

The transfer transistor 325 transfers charge from the photoelectric conversion element 315 to the floating diffusion layer 332 in accordance with a transfer signal TRG5 from the vertical scanning circuit 220. The transfer transistor 326 transfers charge from the photoelectric conversion element 316 to the floating diffusion layer 332 in accordance with a transfer signal TRG6 from the vertical scanning circuit 220. The transfer transistor 327 transfers charge from the photoelectric conversion element 317 to the floating diffusion layer 332 in accordance with a transfer signal TRG7 from the vertical scanning circuit 220. The transfer transistor 328 transfers charge from the photoelectric conversion element 318 to the floating diffusion layer 332 in accordance with a transfer signal TRG8 from the vertical scanning circuit 220.

For example, n-channel metal oxide semiconductor (nMOS) transistors are used as these transfer transistors.

Furthermore, the photoelectric conversion elements 311 to 318, the transfer transistors 321 to 328, and the floating diffusion layers 331 and 332 are arranged on the light receiving chip 201, and the gradation signal generation unit 340 is arranged on the circuit chip 202. Furthermore, the floating diffusion layers 331 and 332 are connected to the gradation signal generation unit 340 via a contact 333 between the chips. Therefore, the path between the photoelectric conversion elements 311 to 318 and the contact 333 is opened and closed by the transfer transistors 321 to 328.

The gradation signal generation unit 340 generates a gradation signal from the potentials of the floating diffusion layers 331 and 332. The gradation signal generation unit 340 includes a reset transistor 341, an amplification transistor 342, and a selection transistor 343.

The reset transistor 341 initializes the floating diffusion layers 331 and 332 in accordance with a reset signal RST received from the vertical scanning circuit 220. The amplification transistor 342 amplifies the potentials of the floating diffusion layers 331 and 332 to generate an analog gradation signal. The selection transistor 343 outputs a gradation signal to the column ADC 240 in accordance with a selection signal SEL from the vertical scanning circuit 220.

The circuits illustrated in FIG. 5 function as eight gradation pixels 300. These eight pixels share the floating diffusion layers 331 and 332 and the gradation signal generation unit 340.

Note that the photoelectric conversion elements 311 to 318 are examples of a first photoelectric conversion element recited in the claims. The transfer transistors 321 to 328 are examples of a first transfer transistor recited in the claims. The contact 333 is an example of a first contact recited in the claims.

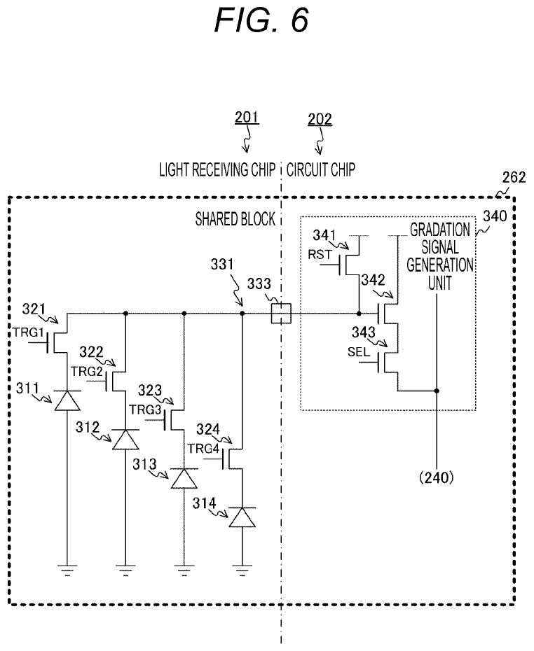

FIG. 6 is a circuit diagram illustrating a configuration example of the shared block 262 in which four gradation pixels 300 are arranged according to the first embodiment of the present technology. The circuit configuration of the shared block 262 is similar to that of the shared block 261 except that the photoelectric conversion elements 315 to 318, the transfer transistors 325 to 328, and the floating diffusion layer 332 are eliminated.

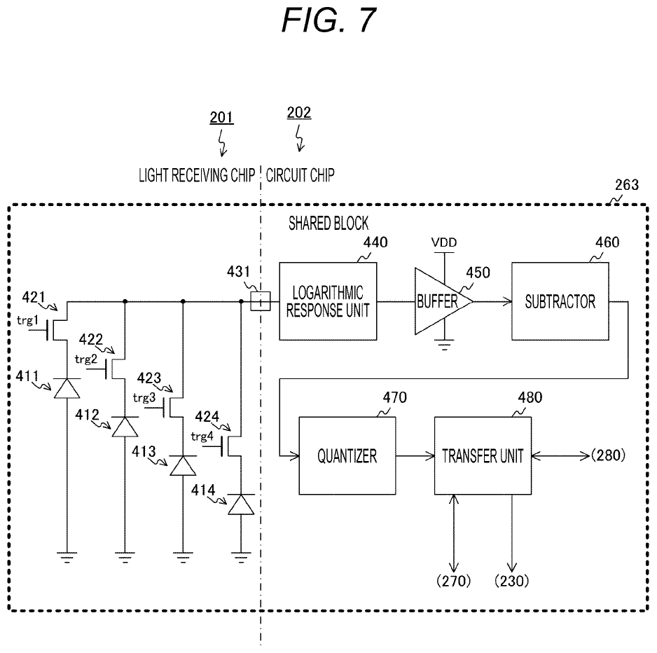

FIG. 7 is a circuit diagram illustrating a configuration example of the shared block 263 in which the EVS pixels 400 are arranged according to the first embodiment of the present technology. The shared block 263 includes photoelectric conversion elements 411 to 414, transfer transistors 421 to 424, a logarithmic response unit 440, a buffer 450, a subtractor 460, a quantizer 470, and a transfer unit 480.

The photoelectric conversion elements 411 to 414 generate photocurrent. The transfer transistor 421 opens and closes a path between the photoelectric conversion element 411 and a contact 431 in accordance with a transfer signal trg1 from the vertical scanning circuit 220. The transfer transistor 422 opens and closes a path between the photoelectric conversion element 412 and the contact 431 in accordance with a transfer signal trg2 from the vertical scanning circuit 220. The transfer transistor 423 opens and closes a path between the photoelectric conversion element 413 and the contact 431 in accordance with a transfer signal trg3 from the vertical scanning circuit 220. The transfer transistor 424 opens and closes a path between the photoelectric conversion element 414 and the contact 431 in accordance with a transfer signal trg4 from the vertical scanning circuit 220. For example, nMOS transistors are used as these transfer transistors. In addition, the contact 431 is connected to the logarithmic response unit 440.

Furthermore, the photoelectric conversion elements 411 to 414 and the transfer transistors 421 to 424 are arranged on the light receiving chip 201, and the logarithmic response unit 440 and subsequent circuits are arranged on the circuit chip 202.

The logarithmic response unit 440 converts a photocurrent into a logarithmic voltage. The buffer 450 outputs an output voltage corresponding to the logarithmic voltage to the subtractor 460. The subtractor 460 obtains the amount of change in the output voltage of the buffer 450 by a subtraction operation.

The subtractor 460 supplies a differential signal indicating the amount of change to the quantizer 470.

The quantizer 470 compares the differential signal from the subtractor 460 with a predetermined threshold, and supplies the comparison result to the transfer unit 480. This comparison result indicates the presence or absence of an address event.

The transfer unit 480 outputs a detection signal on the basis of the comparison result of the quantizer 470. When an address event is detected, the quantizer 470 supplies a request for requesting transmission of a detection signal to the X arbiter 270 and the Y arbiter 280. Then, upon receiving a response to the request from these arbiters, the transfer unit 480 supplies the detection signal to the output unit 230.

The circuits illustrated in FIG. 7 function as four EVS pixels 400. These four pixels share the logarithmic response unit 440 and subsequent circuits.

Note that the photoelectric conversion elements 411 to 414 are examples of a second photoelectric conversion element recited in the claims. The transfer transistors 421 to 424 are examples of a second transfer transistor recited in the claims. The contact 431 is an example of a second contact recited in the claims.

The vertical scanning circuit 220 controls all the transfer transistors in all the EVS pixels 400 to be turned on when an address event is detected. For example, assuming continued detection of address events during operation, the vertical scanning circuit 220 always turns on all of the transfer transistors in the EVS pixel 400. Then, in a case where a predetermined object is detected by analyzing the detection signal of the address event of each of the EVS pixels 400, the vertical scanning circuit 220 drives each of the gradation pixels 300 to generate a gradation signal.

With this control, image data is captured when a predetermined object is detected.

As illustrated in FIGS. 5 to 7, the transfer transistors of the gradation pixel 300 and the EVS pixel 400 are arranged on the light receiving chip 201, and the other transistors are arranged on the circuit chip 202.

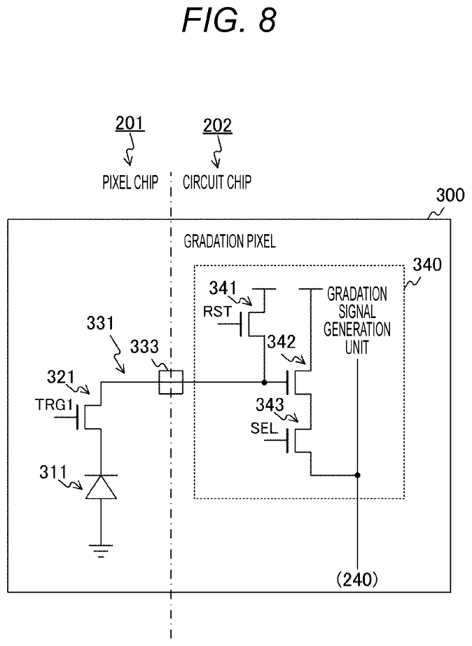

Note that in the shared blocks illustrated in FIGS. 5 to 7, a plurality of pixels shares the floating diffusion layer or the like, but may be configured to not share the floating diffusion layer or the like. In this case, as illustrated in FIG. 8, a subsequent circuit such as the gradation signal generation unit 340 is arranged for each photoelectric conversion element.

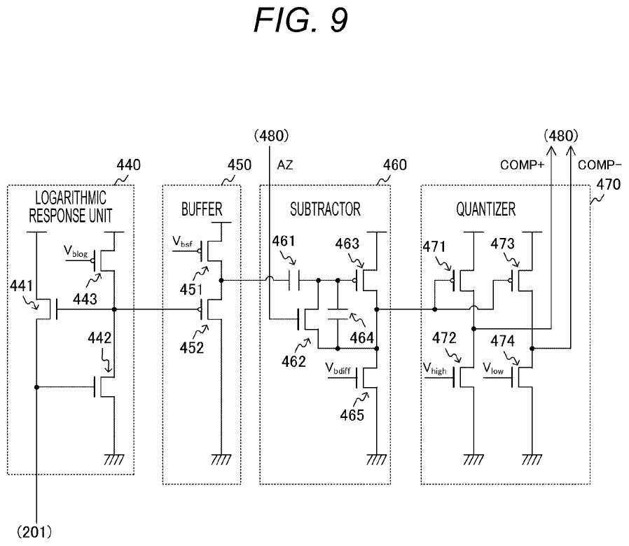

FIG. 9 is a circuit diagram illustrating a configuration example of the logarithmic response unit 440, the buffer 450, the subtractor 460, and the quantizer 470 according to the first embodiment of the present technology.

The logarithmic response unit 440 includes a log transistor 441, a transimpedance amplifier (TIA) 442, and a current source transistor 443. As the log transistor 441 and the TIA 442, for example, nMOS transistors are used. As the current source transistor 443, for example, a p-channel MOS (pMOS) transistor is used.

The log transistor 441 is inserted between the power supply voltage and the light receiving chip 201.

In addition, the current source transistor 443 and the TIA 442 are connected in series between a power supply voltage and a reference voltage (such as ground voltage).

In addition, a connection node between the log transistor 441 and the light receiving chip 201 is connected to the gate of the TIA 442. A connection node of the current source transistor 443 and the TIA 442 is connected to the gate of the log transistor 441 and the buffer 450. A predetermined bias voltage V_{blog} is applied to the gate of the current source transistor 443.

With the above-described circuit configuration, the log transistor 441 converts a photocurrent generated by the photoelectric conversion element 311 and the like (not illustrated) in the light receiving chip 201 into a logarithmic voltage. Moreover, the TIA 442 inversely amplifies the logarithmic voltage. Note that although the loop circuit including the log transistor 441 and the TIA 442 has one stage in FIG. 9, the loop circuit may have two or more stages.

The buffer 450 includes pMOS transistors 451 and 452. These transistors are connected in series between a power supply voltage and a reference voltage with the pMOS transistor 451 on the power supply side. A predetermined bias voltage Vost is input to the gate of the pMOS transistor 451. The logarithmic voltage from the logarithmic response unit 440 is input to the gate of the pMOS transistor 452, and the source of the pMOS transistor 451 is connected to the subtractor 460.

With the above-described circuit configuration, the buffer 450 supplies the output voltage corresponding to the logarithmic voltage to the subtractor 460.

The subtractor 460 includes capacitors 461 and 464, nMOS transistors 462 and 465, and a pMOS transistor 463.

The pMOS transistor 463 and the nMOS transistor 465 are connected in series between a power supply voltage and a reference voltage. With the gate of the pMOS transistor 463 as an input terminal and a connection point of the pMOS transistor 463 and the nMOS transistor 465 as an output terminal, the pMOS transistor 463 and the nMOS transistor 465 function as an inverter that inverts an input signal.

A predetermined bias voltage V_{bdiff} is input to the gate of the nMOS transistor 465.

One end of the capacitor 461 is connected to an output terminal of the buffer 450, and the other end is connected to an input terminal (i.e., gate of pMOS transistor 463) of the inverter. The capacitor 464 is connected in parallel with the inverter. The nMOS transistor 462 opens and closes a path connecting both ends of the capacitor 464 in accordance with a control signal AZ from the transfer unit 480.

With the above-described circuit configuration, the subtractor 460 generates a differential signal indicating the amount of change in the output voltage of the buffer 450 and supplies the differential signal to the quantizer 470.

The quantizer 470 includes pMOS transistors 471 and 473, and nMOS transistors 472 and 474.

The pMOS transistor 471 and the nMOS transistor 472 are connected in series between a power supply voltage and a reference voltage. The pMOS transistor 473 and the nMOS transistor 474 are also connected in series between a power supply voltage and a reference voltage.

Furthermore, the gates of the pMOS transistors 471 and 473 are connected to an output terminal of the subtractor 460. A bias voltage V_{high} indicating an upper limit threshold is applied to the gate of the nMOS transistor 472, and a bias voltage V_{low} indicating a lower limit threshold is applied to the gate of the nMOS transistor 474.

A connection point of the pMOS transistor 471 and the nMOS transistor 472 is connected to the transfer unit 480, and the voltage at this connection point is output as a comparison result COMP+. A connection point of the pMOS transistor 473 and the nMOS transistor 474 is also connected to the transfer unit 480, and the voltage at this connection point is output as a comparison result COMP-. With such connection, the quantizer 470 outputs the high-level comparison result COMP+in a case where the differential signal exceeds the upper limit threshold, and outputs the low-level comparison result COMP-in a case where the differential signal falls below the lower limit threshold.

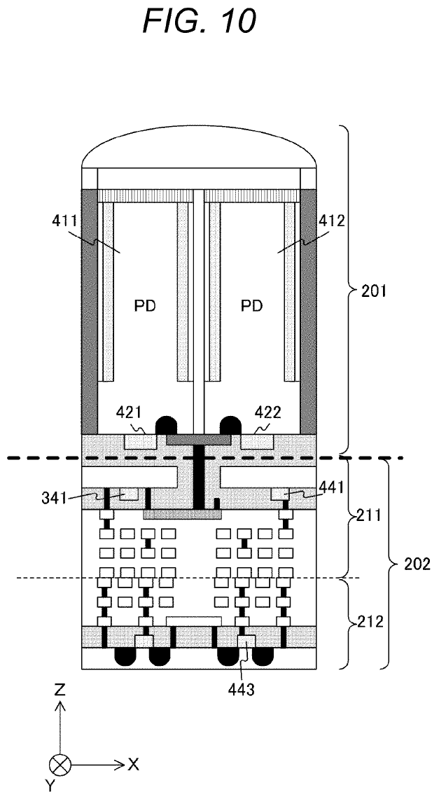

FIG. 10 is an example of a cross-sectional view of the solid-state imaging element 200 according to the first embodiment of the present technology. For example, FIG. 10 is a cross-sectional view when viewed from the Y-axis direction. As illustrated in FIG. 10, a plurality of photoelectric conversion elements such as the photoelectric conversion elements 411 and 412 in the EVS pixel 400 and a plurality of transfer transistors such as the transfer transistors 421 and 422 are arranged on the light receiving chip 201. In the gradation pixel 300, a floating diffusion layer is further arranged.

Furthermore, the circuit chip 202 includes a pixel transistor layer 211 and a circuit layer 212. With the direction toward the light receiving chip 201 as the upper side, the pixel transistor layer 211 is formed immediately below the light receiving chip 201, and the circuit layer 212 is formed below the pixel transistor layer 211.

In the pixel transistor layer 211, the log transistor 441, the TIA 442 (not illustrated), and a transistor in the gradation signal generation unit 340 such as the reset transistor 341 are arranged.

The remaining transistors (such as current source transistor 443) are arranged in the circuit layer 212.

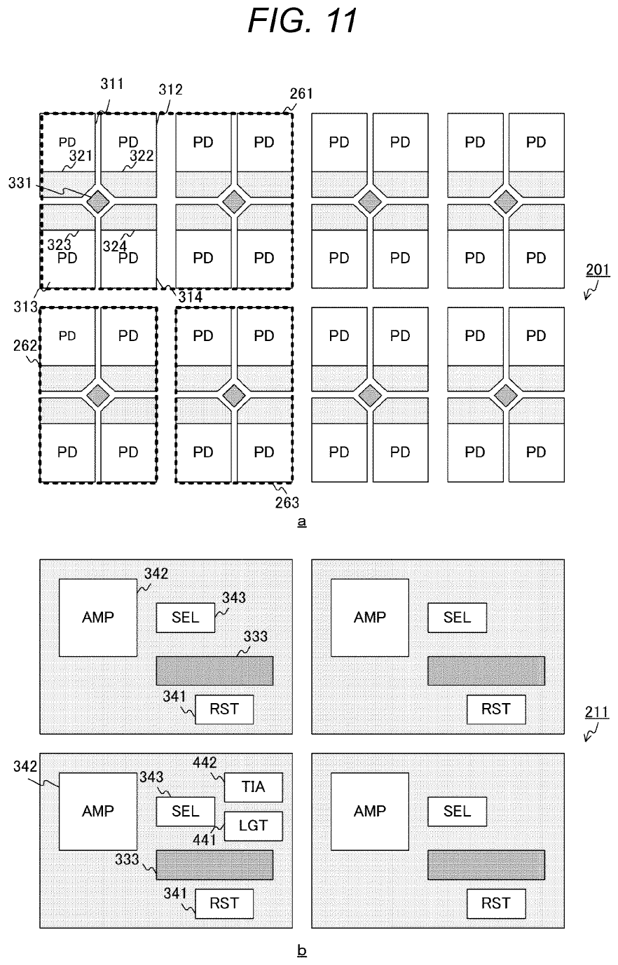

FIG. 11 is a plan view illustrating an example of a layout of the photoelectric conversion elements and the transistors according to the first embodiment of the present technology. In FIG. 11, a illustrates an example of a layout of the light receiving chip 201, and b in FIG. 11 illustrates an example of a layout of the pixel transistor layer 211 in the circuit chip 202.

As illustrated in a of FIG. 11, in the shared block 261 in which the gradation pixels are arranged, the photoelectric conversion elements 311 to 314 are arranged in 2 rows×2 columns, and the transfer transistors 321 to 324 are arranged between them and the floating diffusion layer 331. The remaining four photoelectric conversion elements and four transfer transistors are arranged in a similar layout. Additionally, in the shared blocks 262 and 263, photoelectric conversion elements and transistors are arranged in a similar layout.

As described above, a transfer transistor unnecessary for detecting an address event is arranged in the shared block 263 in which the EVS gradation pixels are arranged. Therefore, as illustrated in a of FIG. 11, the layout of the gradation pixels and the layout of the EVS pixels can be aligned.

Furthermore, as illustrated in b of FIG. 11, the contact 333, the reset transistor 341, the amplification transistor 342, and the selection transistor 343 are arranged immediately below the shared block 261.

The contact 333, the reset transistor 341, the amplification transistor 342, and the selection transistor 343 are arranged immediately below the shared blocks 262 and 263 as well. In addition, the log transistor 441 and the TIA 442 are further arranged in this region. The remaining transistors (such as current source transistor 443) are arranged in the circuit layer 212 (not illustrated) immediately below the pixel transistor layer 211.

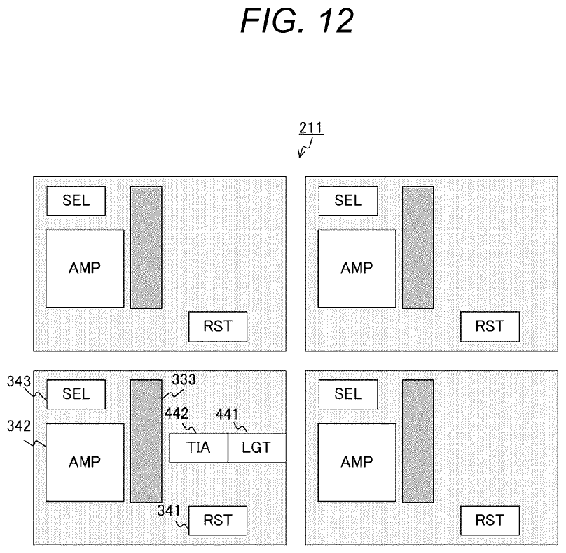

Note that as illustrated in FIG. 12, by bringing the amplification transistor 342 and the selection transistor 343 to the left side, the space on the right side for the log transistor 441 and the TIA 442 can be expanded. In FIG. 12, a sufficient space is secured by arranging the amplification transistor 342 and the selection transistor 343 in the Y-axis direction and setting the direction of the long side of the contact 333 to the Y-axis direction.

Here, a configuration in which the transfer transistor is not arranged in the EVS pixel 400 is assumed as a comparative example.

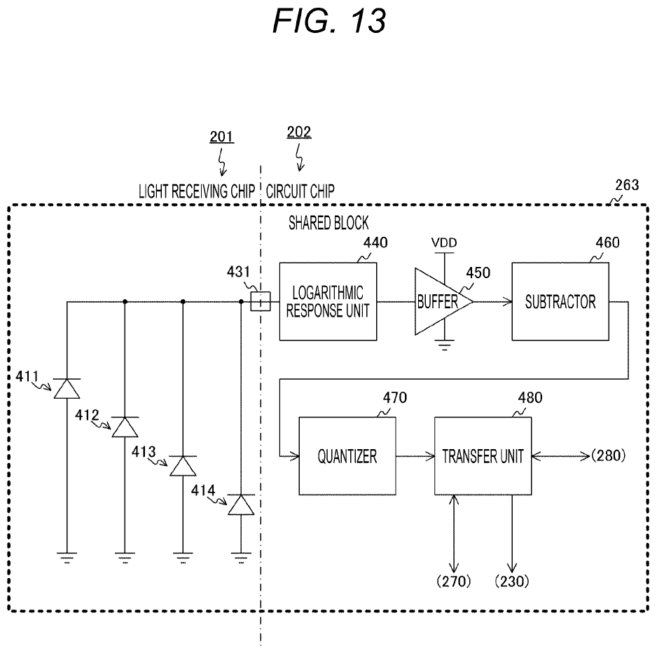

FIG. 13 is a circuit diagram illustrating a configuration example of a shared block 263 in a comparative example. In this comparative example, the transfer transistors 421 to 424 are not arranged in the shared block 263, and photoelectric conversion elements 411 to 414 are commonly connected to a logarithmic response unit 440 via a contact 431.

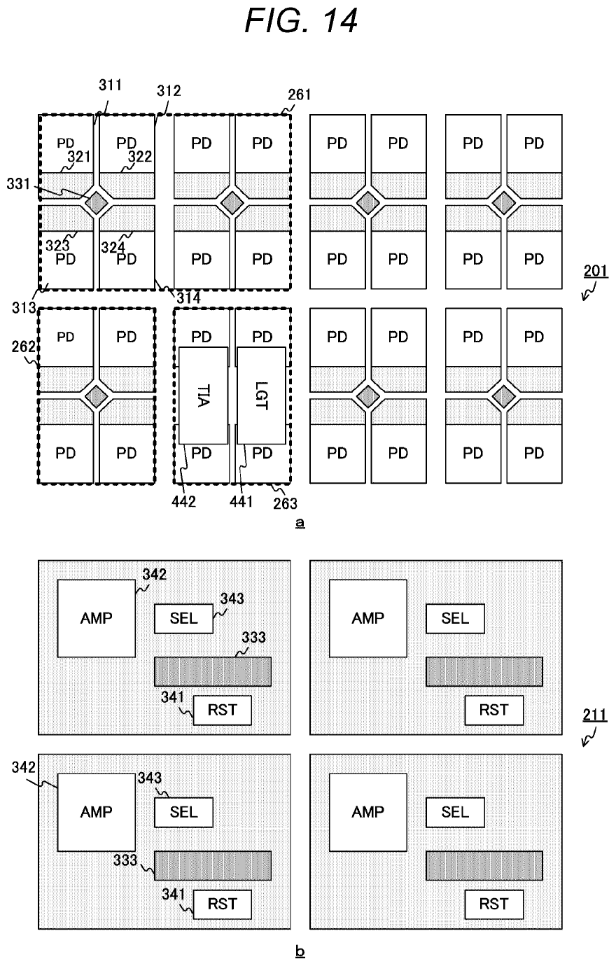

FIG. 14 is a plan view illustrating the example of the layout in the comparative example. In FIG. 14, a illustrates an example of a layout of a light receiving chip 201, and b in FIG. 14 illustrates an example of a layout of a pixel transistor layer 211 in a circuit chip 202.

As illustrated in a of FIG. 14, in the comparative example, in the shared block 263, a log transistor 441 and a TIA 442 are arranged instead of the transfer transistor. Furthermore, as illustrated in b of FIG. 14, the log transistor 441 and the TIA 442 are not arranged in the pixel transistor layer 211.

As illustrated in a of FIG. 14, in the comparative example, since the log transistor 441 and the TIA 442 are arranged on the light receiving chip 201, the light receiving area of the shared block 263 is reduced by these transistors. Furthermore, in the light receiving chip 201, since the layout of the gradation pixels 300 and the layout of the EVS pixels 400 are different, it is necessary to separately create the gradation pixels 300 and the EVS pixels 400, and there is a possibility that the number of man-hours at the time of creating the light receiving chip 201 increases. Moreover, since the log transistor 441 and the TIA 442 in the EVS pixel 400 are arranged in the light receiving chip 201, noise generated in the logarithmic response unit 440 in the EVS pixel 400 may interfere with the gradation signal of the gradation pixel 300.

On the other hand, in the first embodiment, since only the transfer transistor is arranged on the light receiving chip 201 and the log transistor 441 and the TIA 442 are arranged on the circuit chip 202, the light receiving area of the shared block 263 is not reduced.

Furthermore, in the first embodiment, since the layout of the gradation pixels 300 and the layout of the EVS pixel 400 are aligned, it is not necessary to separately create the gradation pixels 300 and the EVS pixels 400, and man-hours can be reduced as compared with the comparative example. Furthermore, in the first embodiment, since the log transistor 441 and the TIA 442 are arranged on the circuit chip 202, interference can be suppressed as compared with the comparative example.

As described above, according to the first embodiment of the present technology, since the transfer transistor of the gradation pixel 300 and the EVS pixel 400 is arranged on the light receiving chip 201, the layout of the gradation pixels 300 and the layout of the EVS pixels 400 can be aligned. As a result, man-hours can be reduced as compared with the comparative example. In addition, the image quality can be improved and interference can be suppressed as compared with the comparative example.

### Modification

In the first embodiment described above, four transistors are arranged in the gradation pixel 300, but with this configuration, the charge-voltage conversion efficiency of the floating diffusion layer cannot be controlled. A solid-state imaging element 200 in a modification of the first embodiment is different from that of the first embodiment in that a transistor for controlling the charge-voltage conversion efficiency is added.

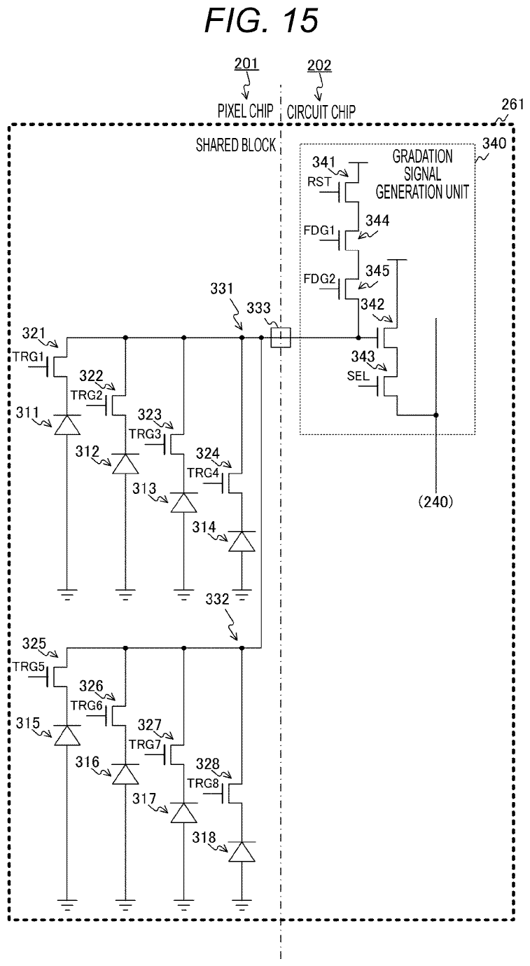

FIG. 15 is a circuit diagram illustrating a configuration example of a shared block 261 in which eight gradation pixels 300 are arranged according to the modification of the first embodiment of the present technology. In the modification of the first embodiment, FDG transistors 344 and 345 are added in a gradation signal generation unit 340. These transistors are inserted in series between a reset transistor 341 and floating diffusion layers 331 and 332.

The FDG transistors 344 and 345 control the charge-voltage conversion efficiency of the floating diffusion layers 331 and 332 in accordance with control signals FDG1 and FDG2 from a vertical scanning circuit 220. Note that it is also possible to arrange only one of the FDG transistors 344 and 345. Furthermore, the FDG transistors 344 and 345 are examples of a conversion efficiency control transistor recited in the claims.

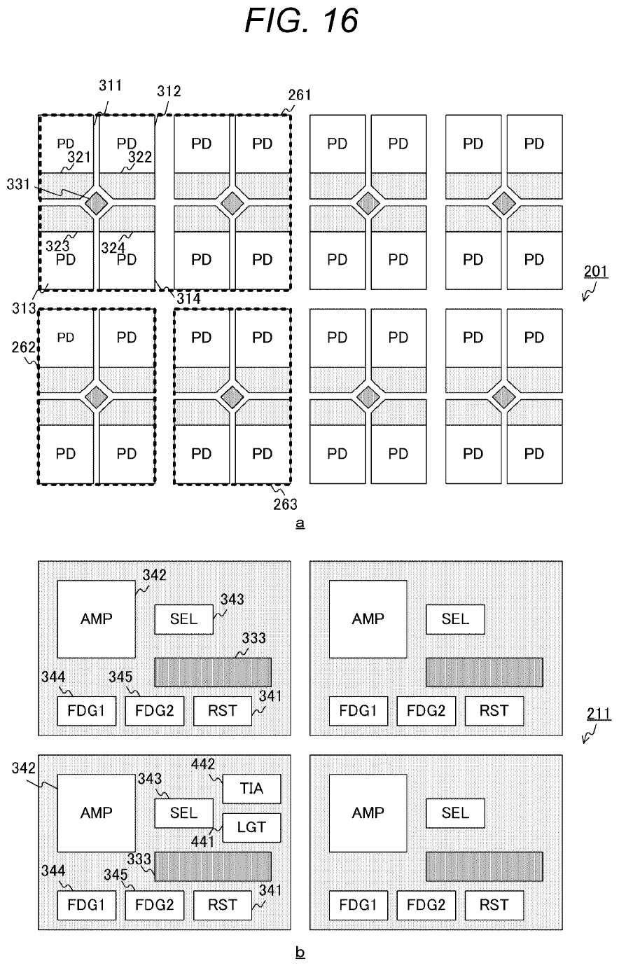

FIG. 16 is a plan view illustrating the example of the layout according to the modification of the first embodiment of the present technology. In FIG. 16, a illustrates an example of a layout of a light receiving chip 201, and b in FIG. 16 illustrates an example of a layout of a pixel transistor layer 211 in a circuit chip 202.

As illustrated in b of FIG. 16, the FDG transistors 344 and 345 are further arranged immediately below a shared block such as a shared block 262.

As described above, according to the modification of the first embodiment of the present technology, since the FDG transistors 344 and 345 are further arranged, the gradation pixel 300 can control the charge-voltage conversion efficiency.

### 2. Second Embodiment

In the first embodiment described above, the photoelectric conversion elements are individually arranged in the plurality of gradation pixels 300 and the plurality of EVS pixels 400, but with this configuration, it is difficult to improve the image quality of the image data. A solid-state imaging element 200 according to a second embodiment is different from that in the first embodiment in that a photoelectric conversion element on the EVS side is used on the gradation side.

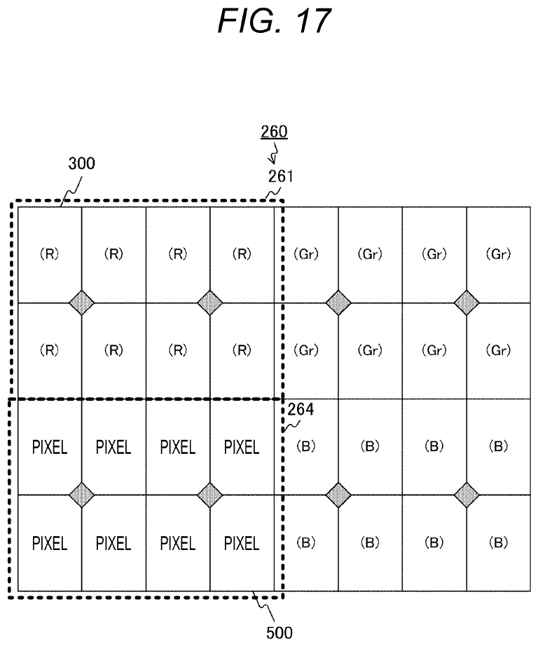

FIG. 17 is an example of a plan view of a pixel array unit 260 according to the second embodiment of the present technology. The pixel array unit 260 of the second embodiment is different from that of the first embodiment in including a shared block 264 instead of the shared blocks 262 and 263.

In the shared block 264, eight pixels 500 are arranged. These pixels 500 function as Gb pixels (i.e., gradation pixels 300) or EVS pixels.

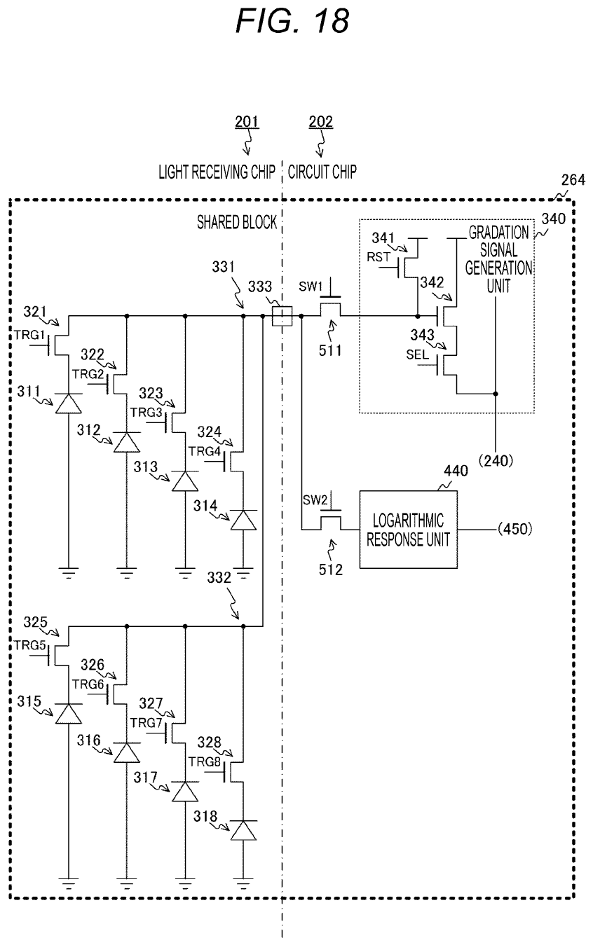

FIG. 18 is a circuit diagram illustrating a configuration example of the shared block 264 according to the second embodiment of the present technology. The shared block 264 according to the second embodiment includes photoelectric conversion elements 311 to 318, transfer transistors 321 to 328, and floating diffusion layers 331 and 332. In addition, the shared block 264 includes switching transistors 511 and 512, a gradation signal generation unit 340, a logarithmic response unit 440, a buffer 450, a subtractor 460, a quantizer 470, and a transfer unit 480. In FIG. 18, the circuits subsequent to the buffer 450 are omitted.

A connection configuration among the photoelectric conversion elements 311 to 318, the transfer transistors 321 to 328, and the floating diffusion layer 331 in the gradation pixel 300 is similar to that of the first embodiment.

The switching transistor 511 opens and closes a path between a contact 333 and the gradation signal generation unit 340 in accordance with a control signal SW1 from a vertical scanning circuit 220. The switching transistor 512 opens and closes a path between the contact 333 and the logarithmic response unit 440 in accordance with a control signal SW2 from the vertical scanning circuit 220.

In the solid-state imaging element 200, an EVS mode for detecting an address event and a gradation mode for generating a gradation signal are set in a time division manner. In the EVS mode, the vertical scanning circuit 220 performs control to turn on the eight transfer transistors and the switching transistor 512, and turn off the switching transistor 511. In this case, the eight pixels function as EVS pixels. Furthermore, in the gradation mode, the vertical scanning circuit 220 turns on and off the transfer transistor and the like while performing control to turn on the switching transistor 511 and turn off the switching transistor 512. In this case, the eight pixels function as gradation pixels.

As described above, the eight photoelectric conversion elements can be used on the gradation side or the EVS side. In other words, the four photoelectric conversion elements on the EVS side can be used on the gradation side as compared with the first embodiment in which four of the eight photoelectric conversion elements are used on the gradation side and the remaining photoelectric conversion elements are used on the EVS side. As a result, image quality of image data can be improved. In addition, since the contact 333 can be shared between the gradation pixel and the EVS pixel, the number of contacts can be reduced as compared with the first embodiment in which the contact is arranged in each of the gradation pixel and the EVS pixel.

In addition, similarly to the first embodiment, in the second embodiment, man-hours can be reduced and interference can be suppressed as compared with the comparative example.

Note that the gradation signal generation unit 340 and the logarithmic response unit 440 are shared by 8 pixels, but the present invention is not limited to this configuration. The gradation signal generation unit 340 and the logarithmic response unit 440 can also be arranged for each pixel.

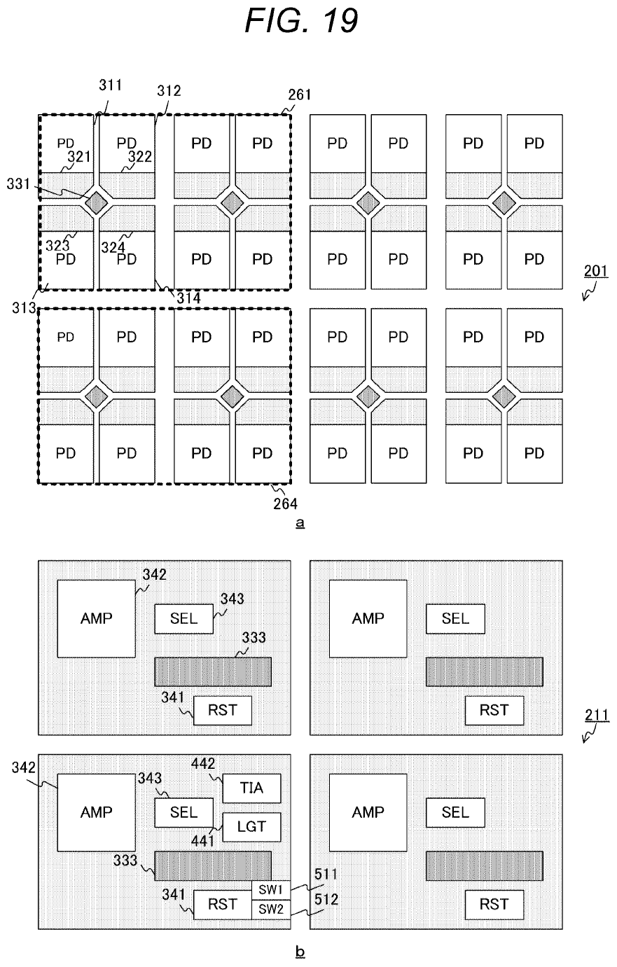

FIG. 19 is a plan view illustrating the example of the layout according to the second embodiment of the present technology. In FIG. 19, a illustrates an example of a layout of a light receiving chip 201, and b in FIG. 19 illustrates an example of a layout of a pixel transistor layer 211 in a circuit chip 202.

As illustrated in b of FIG. 19, immediately below the shared block 264, the switching transistors 511 and 512 are further arranged in addition to a reset transistor 341 and the like.

Note that the modification of the first embodiment can be applied to the second embodiment.

As described above, according to the second embodiment of the present technology, since the switching transistors 511 and 512 are arranged, the four photoelectric conversion elements on the EVS side can be used on the gradation side, and the image quality can be improved.

### 3. Third Embodiment

In the second embodiment described above, the switching transistors 511 and 512 are arranged in the shared block 264, but it is preferable to further reduce the number of circuits. A solid-state imaging element 200 in a third embodiment is different from that in the second embodiment in that the switching transistor 511 is eliminated.

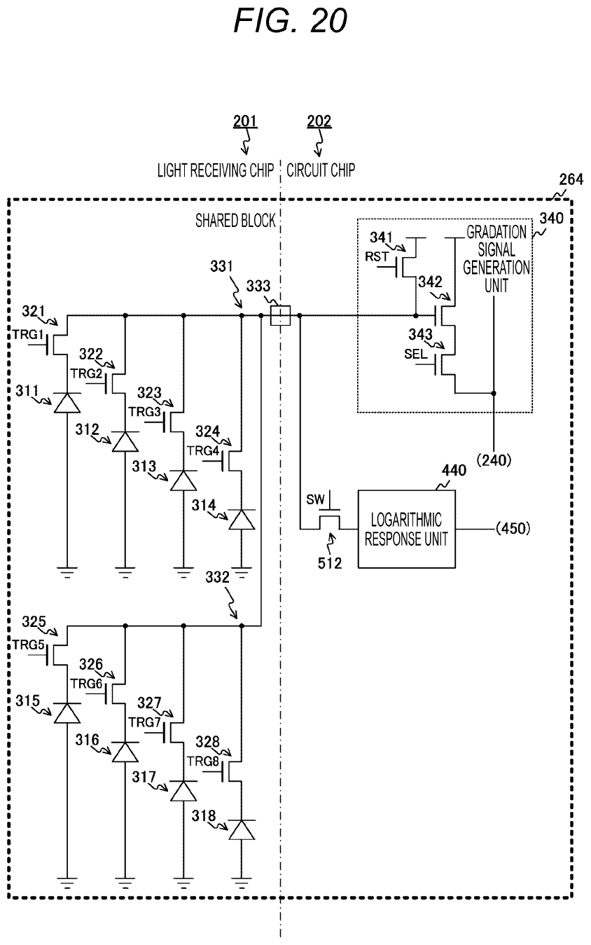

FIG. 20 is a circuit diagram illustrating a configuration example of a shared block 264 according to the third embodiment of the present technology. The shared block 264 in the third embodiment is different from that in the second embodiment in that the switching transistor 511 is eliminated. A contact 333 is connected to a logarithmic response unit 440.

In an EVS mode, a vertical scanning circuit 220 turns on eight transfer transistors and a switching transistor 512, and turns off a selection transistor 343. Furthermore, in a gradation mode, the vertical scanning circuit 220 turns on and off the transfer transistor and the like while turning off the switching transistor 512.

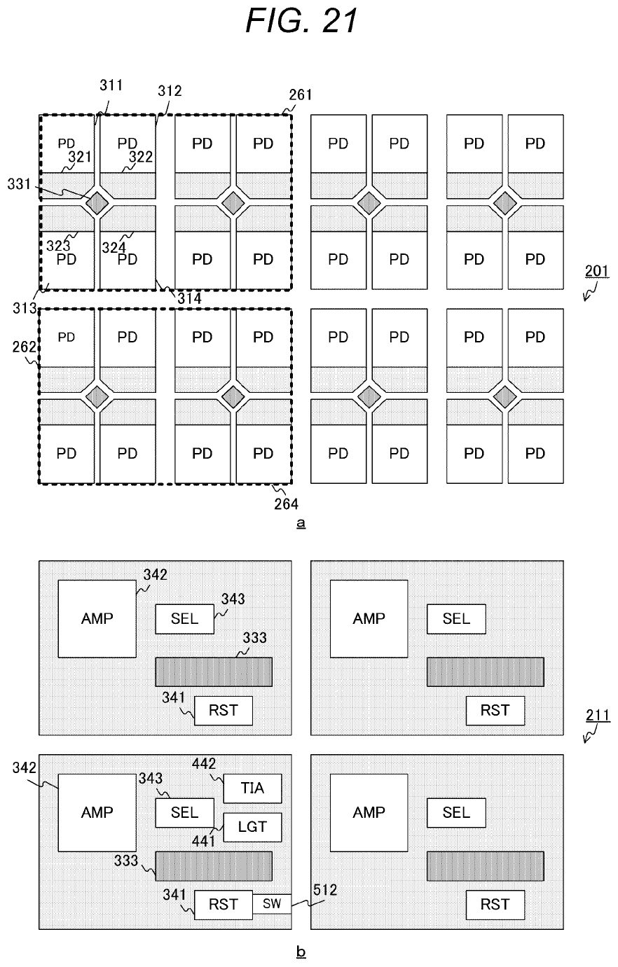

FIG. 21 is a plan view illustrating the example of the layout according to the third embodiment of the present technology. In FIG. 21, a illustrates an example of a layout of a light receiving chip 201, and b in FIG. 21 illustrates an example of a layout of a pixel transistor layer 211 in a circuit chip 202. As illustrated in b of FIG. 21, the switching transistor 511 is eliminated.

Note that the modification of the first embodiment can be applied to the third embodiment.

As described above, according to the third embodiment of the present technology, since the switching transistor 511 is not arranged, the circuit scale of the pixel can be reduced.

### 4. Example of Application to Mobile Body

The technology according to the present disclosure (present technology) can be applied to various products. For example, the technology according to the present disclosure may also be implemented as a device mounted on any type of mobile body such as an automobile, an electric automobile, a hybrid electric automobile, a motorcycle, a bicycle, a personal mobility, an airplane, a drone, a ship, and a robot.

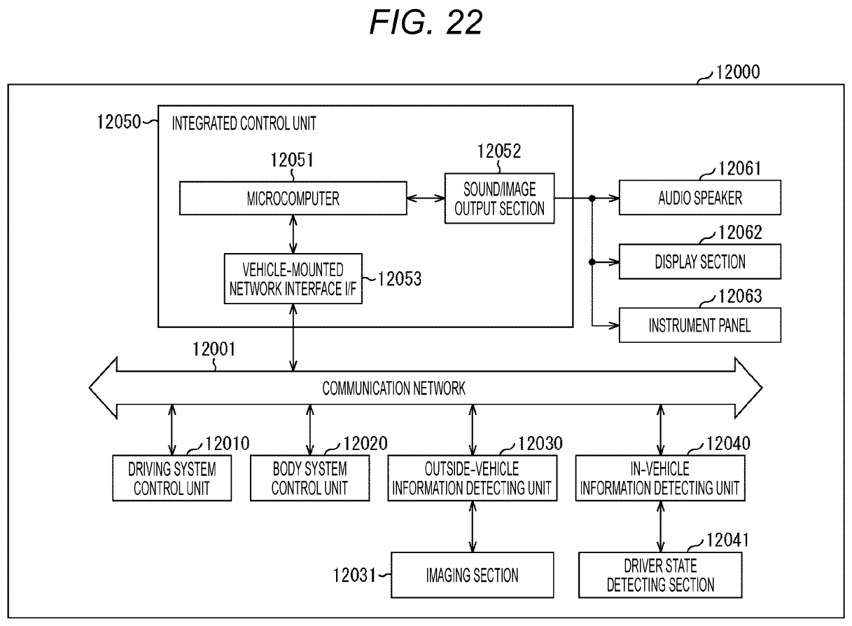

FIG. 22 is a block diagram illustrating a schematic configuration example of a vehicle control system which is an example of a mobile body control system to which the technology according to the present disclosure can be applied.

A vehicle control system 12000 includes a plurality of electronic control units connected to each other via a communication network 12001. In the example illustrated in FIG. 22, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light.

The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example in FIG. 22, an audio speaker 12061, a display section 12062, and an instrument panel 12063 are illustrated as output devices. The display section 12062 may, for example, include at least one of an on-board display and a head-up display.

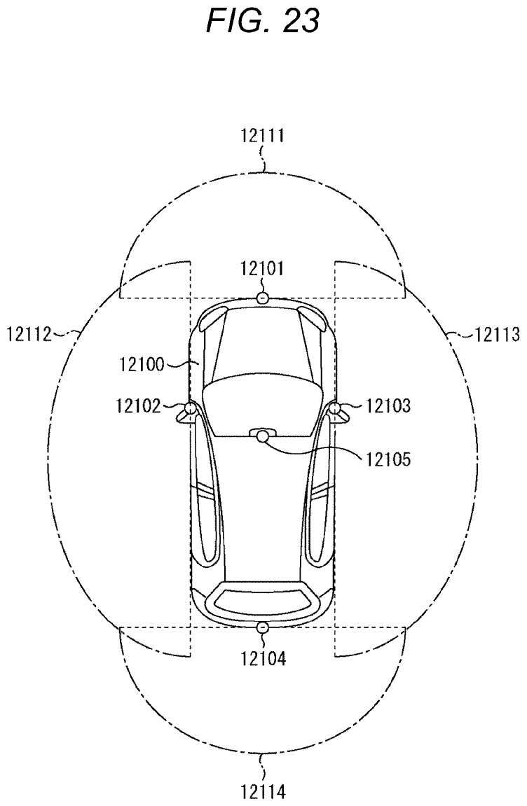

FIG. 23 is a diagram illustrating an example of an installation position of the imaging section 12031.

In FIG. 23, the imaging section 12031 includes imaging sections 12101, 12102, 12103, 12104, and 12105.

The imaging sections 12101, 12102, 12103, 12104, 12105 are provided, for example, at positions such as a front nose, a sideview mirror, a rear bumper, a back door, and an upper portion of a windshield in the interior of a vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly images of sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 23 illustrates an example of imaging ranges of the imaging sections 12101 to 12104. An imaging range 12111 represents the imaging range of the imaging section 12101 provided to the front nose.

Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information.

For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays.

The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to, for example, the imaging section 12031 among the configurations described above. Specifically, for example, the imaging device 100 in FIG. 1 can be applied to the imaging section 12031. By applying the technology according to the present disclosure to the imaging section 12031, it is possible to reduce man-hours and reduce the cost of the system.

Note that the above-described embodiments describe examples for embodying the present technology, and there is a correspondence relationship between matters in the embodiments and the matters specifying the invention in the claims. Similarly, the matters specifying the invention in the claims and matters with the same names in the embodiments of the present technology have correspondence relationships. Note, however, that the present technology is not limited to the embodiments and may be embodied with various modifications of the embodiment without departing from the spirit thereof.

Note that effects described in the present specification are merely examples and are not limitative, and other effects may be provided.

Note that the present technology may also have the following configurations.

(1) A solid-state imaging element including
a light receiving chip on which a transfer transistor that opens and closes a path between a photoelectric conversion element and a contact is arranged among a gradation pixel that generates a gradation signal according to a light amount and a detection pixel that detects whether or not a change amount of luminance exceeds a predetermined threshold, and
a circuit chip on which a transistor that does not correspond to the transfer transistor among the gradation pixel and the detection pixel is arranged.

(2) The solid-state imaging element according to (1), in which:
the gradation pixel includes a floating diffusion layer and a gradation signal generation unit that generates the gradation signal from a potential of the floating diffusion layer;
the detection pixel includes a logarithmic response unit;
the floating diffusion layer is arranged on the light receiving chip; and
the gradation signal generation unit and the logarithmic response unit are arranged on the circuit chip.

(3) The solid-state imaging element according to (2), in which:
the photoelectric conversion element includes a first photoelectric conversion element in the gradation pixel and a second photoelectric conversion element in the detection pixel;
the contact includes a first contact connected to the gradation signal generation unit and a second contact connected to the logarithmic response unit; and
the transfer transistor includes a first transfer transistor that opens and closes a path between the first photoelectric conversion element and the first contact and a second transfer transistor that opens and closes a path between the second photoelectric conversion element and the second contact.

(4) The solid-state imaging element according to (2), in which a first switching transistor that opens and closes a path between the contact and the gradation signal generation unit and a second switching transistor that opens and closes a path between the contact and the logarithmic response unit are further arranged on the circuit chip.

(5) The solid-state imaging element according to (2), in which
a switching transistor that opens and closes a path between the contact and the logarithmic response unit is further arranged on the circuit chip, and
the contact is connected to the logarithmic response unit.

(6) The solid-state imaging element according to any one of (2) to (5), in which
the gradation signal generation unit includes: a reset transistor that initializes the floating diffusion layer;
an amplification transistor that amplifies a potential of the floating diffusion layer to generate the gradation signal; and
a selection transistor that supplies the gradation signal to a vertical signal line in accordance with a predetermined selection signal.

(7) The solid-state imaging element according to (6), in which the gradation signal generation unit further includes a conversion efficiency control transistor that controls charge-voltage conversion efficiency of the floating diffusion layer.

(8) The solid-state imaging element according to (1), in which:
the detection pixel includes
a logarithmic response unit that converts a photocurrent into a logarithmic voltage,
a buffer that outputs an output voltage corresponding to the logarithmic voltage,
a subtractor that obtains a change amount of the output voltage by a subtraction operation,
a quantizer that compares the change amount with a predetermined threshold to generate a comparison result, and
a transfer unit that outputs a detection signal on the basis of the comparison result, in which
the logarithmic response unit, the buffer, the subtractor, the quantizer, and the transfer unit are arranged on the circuit chip.

(9) The solid-state imaging element according to (8), in which:
the circuit chip includes a pixel transistor layer and a circuit layer;
the logarithmic response unit includes a current source transistor that supplies a predetermined current,
a log transistor that converts the photocurrent into the logarithmic voltage, and
a transimpedance amplifier that inversely amplifies the logarithmic voltage;
the gradation signal generation unit, the log transistor, and the transimpedance amplifier are arranged on the pixel transistor layer; and
the current source transistor, the buffer, the subtractor, the quantizer, and the transfer unit are arranged on the circuit layer.

(10) An imaging device including:
a light receiving chip on which a transfer transistor that opens and closes a path between a photoelectric conversion element and a contact is arranged among a gradation pixel that generates a gradation signal according to a light amount and a detection pixel that detects whether or not a change amount of luminance exceeds a predetermined threshold;
a circuit chip on which a transistor that does not correspond to the transfer transistor among the gradation pixel and the detection pixel is arranged; and a recording unit that records data from the circuit chip.

### REFERENCE SIGNS LIST

100 Imaging device
110 Imaging lens
120 Recording unit
130 Control unit
200 Solid-state imaging element
201 Light receiving chip
202 Circuit chip
211 Pixel transistor layer
212 Circuit layer
220 Vertical scanning circuit
230 Output unit
240 Column ADC
250 Load MOS circuit
260 Pixel array unit
261 to 264 Shared block
270 X arbiter
280 Y arbiter
300 Gradation pixel
311 to 318, 411 to 414 Photoelectric conversion element
321 to 328, 421 to 424 Transfer transistor
331, 332 Floating diffusion layer
333, 431 Contact
340 Gradation signal generation unit
341 Reset transistor
342 Amplification transistor
343 Selection transistor
344, 345 FDG transistor
400 EVS pixel
440 Logarithmic response unit
441 Log transistor
442 TIA
443 Current source transistor
450 Buffer
451, 452, 463, 471, 473 pMOS transistor
460 Subtractor
461, 464 Capacitor
462, 465, 472, 474 nMOS transistor
470 Quantizer
480 Transfer unit
500 Pixel
511, 512 Switching transistor
12031 Imaging section

1. A solid-state imaging element comprising
a light receiving chip on which a transfer transistor that opens and closes a path between a photoelectric conversion element and a contact is arranged among a gradation pixel that generates a gradation signal according to a light amount and a detection pixel that detects whether or not a change amount of luminance exceeds a predetermined threshold, and
a circuit chip on which a transistor that does not correspond to the transfer transistor among the gradation pixel and the detection pixel is arranged.

2. The solid-state imaging element according to claim 1, wherein:
the gradation pixel includes a floating diffusion layer and a gradation signal generation unit that generates the gradation signal from a potential of the floating diffusion layer;
the detection pixel includes a logarithmic response unit;
the floating diffusion layer is arranged on the light receiving chip; and
the gradation signal generation unit and the logarithmic response unit are arranged on the circuit chip.

3. The solid-state imaging element according to claim 2, wherein
the photoelectric conversion element includes a first photoelectric conversion element in the gradation pixel and a second photoelectric conversion element in the detection pixel;
the contact includes a first contact connected to the gradation signal generation unit and a second contact connected to the logarithmic response unit; and
the transfer transistor includes a first transfer transistor that opens and closes a path between the first photoelectric conversion element and the first contact and a second transfer transistor that opens and closes a path between the second photoelectric conversion element and the second contact.

4. The solid-state imaging element according to claim 2, wherein a first switching transistor that opens and closes a path between the contact and the gradation signal generation unit and a second switching transistor that opens and closes a path between the contact and the logarithmic response unit are further arranged on the circuit chip.

5. The solid-state imaging element according to claim 2, wherein
a switching transistor that opens and closes a path between the contact and the logarithmic response unit is further arranged on the circuit chip, and
the contact is connected to the logarithmic response unit.

6. The solid-state imaging element according to claim 2, wherein
the gradation signal generation unit includes:
a reset transistor that initializes the floating diffusion layer;
an amplification transistor that amplifies a potential of the floating diffusion layer to generate the gradation signal; and
a selection transistor that supplies the gradation signal to a vertical signal line in accordance with a predetermined selection signal.

7. The solid-state imaging element according to claim 6, wherein the gradation signal generation unit further includes a conversion efficiency control transistor that controls charge-voltage conversion efficiency of the floating diffusion layer.

8. The solid-state imaging element according to claim 1, wherein
the detection pixel includes
a logarithmic response unit that converts a photocurrent into a logarithmic voltage,
a buffer that outputs an output voltage corresponding to the logarithmic voltage,
a subtractor that obtains a change amount of the output voltage by a subtraction operation,
a quantizer that compares the change amount with a predetermined threshold to generate a comparison result, and
a transfer unit that outputs a detection signal on a basis of the comparison result, wherein
the logarithmic response unit, the buffer, the subtractor, the quantizer, and the transfer unit are arranged on the circuit chip.

9. The solid-state imaging element according to claim 8, wherein:
the circuit chip includes a pixel transistor layer and a circuit layer;
the logarithmic response unit includes a current source transistor that supplies a predetermined current,
a log transistor that converts the photocurrent into the logarithmic voltage, and
a transimpedance amplifier that inversely amplifies the logarithmic voltage;
the gradation signal generation unit, the log transistor, and the transimpedance amplifier are arranged on the pixel transistor layer; and
the current source transistor, the buffer, the subtractor, the quantizer, and the transfer unit are arranged on the circuit layer.

10. An imaging device comprising:
a light receiving chip on which a transfer transistor that opens and closes a path between a photoelectric conversion element and a contact is arranged among a gradation pixel that generates a gradation signal according to a light amount and a detection pixel that detects whether or not a change amount of luminance exceeds a predetermined threshold;
a circuit chip on which a transistor that does not correspond to the transfer transistor among the gradation pixel and the detection pixel is arranged; and
a recording unit that records data from the circuit chip.
